(19) United States
(12) Patent Application Publication
(10) Pub. No.: US 2026/0359846 A1
(43) Pub. Date: Nov. 12, 2026

(54) DIMENSIONAL ANALYSIS AND VISUALIZATION OF DEMAND FORECASTING MODEL PERFORMANCE

(71) Applicant: Target Brands, Inc., Minneapolis, MN (US)

(72) Inventors: James Broomfield, Cottage Grove, MN (US); Kumar Gavade, San Francisco, CA (US); Sahil Gupta, Seattle, WA (US); Reed Thunstrom, Minneapolis, MN (US)

(21) Appl. No.: 19/202,483

(22) Filed: May 8, 2025

(51) Int. Cl. G06Q 30/0202

(52) U.S. Cl. CPC G06Q 30/0202

(57) ABSTRACT

A model evaluation and comparison system is disclosed. The model evaluation and comparison system analyzes performance differences between multiple forecasting models across configurable dimensions. The system determines error values by comparing model-generated forecasts against validation data, then aggregates these errors across dimensions. In some embodiments, a first plurality of models and a second plurality of models are evaluated and compared. Such a comparison can include comparing error values for the first plurality of models with error values for the second plurality of models, including aggregate error values across configurable dimensions. Additionally, aspects of the present disclosure include graphs and charts showing results of comparing these systems of models.

### BACKGROUND

Model evaluation is the process of measuring a model's performance on relevant tasks using appropriate metrics. It assesses how well a model generalizes to unseen data and may include additional concerns like robustness and interpretability. For example, model evaluation can include assessing how well a model performs at forecasting unseen time series data that occurs at a later time from the data on which the model is trained. Model comparison can involve analyzing multiple models to determine which performs best. In some instances, comparing models is challenging because small improvements in one metric may come at the cost of others, and differences might not generalize across datasets. The challenge grows when models are part of larger systems of models, which may obscure the impact of any single model, making visible and meaningful comparisons difficult.

### SUMMARY

In general terms, this disclosure relates to a model evaluation and comparison system. In some embodiments, and by non-limiting example, a first plurality of models and a second plurality of models are evaluated and compared. Such a comparison can include comparing forecast for a given item and for a collection of items. Additionally, aspects of the present disclosure include graphs and charts showing results of comparing systems of models.

In an example aspect, a system is disclosed. The system comprises a first plurality of models comprising a first model and a second model, wherein the first model generates a first forecast for a first item of a plurality of items and wherein the second model generates a second forecast for a second item of the plurality of items; a second plurality of models comprising a third model and a fourth model, wherein the third model generates a third forecast for the first item and wherein the fourth model generates a fourth forecast for the second item; a model evaluation system configured to: generate, using the first plurality of models, a first plurality of forecasts, the first plurality of forecasts comprising the first forecast for the first item and the second forecast for the second item; generate, using the second plurality of models, a second plurality of forecasts, the second plurality of forecasts comprising the third forecast for the first item and the fourth forecast for the second item; compare the first plurality of forecasts to validation data to determine a first plurality of error values comprising a first error value for the first item and a second error value for the second item; compare the second plurality of forecasts to the validation data to determine a second plurality of error values comprising a third error value for the first item and a fourth error value for the second item; for a first dimension including with the first item: aggregate the first error value for the first item with other error values of the first plurality of error values for other items of the plurality of items belonging to the first dimension to generate a first aggregate error for the first dimension; aggregate the third error value for the first item with other error values of the second plurality of error values for the other items of the plurality of items belonging the first dimension to generate a second aggregate error for the first dimension; based on the second aggregate error being less than the first aggregate error, determine that the second plurality of models is superior to the first plurality of models for the first dimension; for a second dimension associated with the second item: aggregate the second error value for the second item with other error values of the first plurality of error values for other items of the plurality of items belonging to the second dimension to generate a third aggregate error for the second dimension; aggregate the fourth error value for the second item with other error values of the second plurality of error values for the other items of the plurality of items belonging to the second dimension to generate a fourth aggregate error for the second dimension; based on the fourth aggregate error being greater than the third aggregate error, determine that the second plurality of models is inferior to the first plurality of models for the second dimension; a user interface configured to: display a table user interface element comprising rows representing a plurality of dimensions including the first dimension and the second dimension, a first column including first model error results from the first plurality of models, a second column including second model error results from the second plurality of models, and a third column comprising labels indicating whether, for each dimension of the plurality of dimensions, the second plurality of models improved upon the first plurality of models, wherein the third column includes a first label indicating that the second plurality of models is superior to the first plurality of models for the first dimension and a second label indicating that the second plurality of models is inferior to the first plurality of models for the second dimension; and display a chart user interface element comprising, for the first dimension, a y-axis showing errors associated with second plurality of models and an x-axis showing errors associated with the first plurality of models, a plurality of points, wherein each point corresponds to an item of the plurality of items, and an identity line that visually separates improved forecasts and degraded forecasts of the second plurality of models relative to the first plurality of models, wherein a point representing the first item is positioned in the graph with a x-value greater than a y-value to show that the third model is superior to the first model for the first item.

In a further example aspect, a method is disclosed. The method comprises generating, using a first plurality of models, a first plurality of forecasts, the first plurality of forecasts comprising a first forecast for a first item of a plurality of items; generating, using a second plurality of models, a second plurality of forecasts, the second plurality of forecasts comprising a second forecast for the first item; comparing the first plurality of forecasts to validation data to determine a first plurality of error values comprising a first error value for the first item; comparing the second plurality of forecasts to the validation data to determine a second plurality of error values comprising a second error value for the first item; for a first dimension including with the first item: aggregating the first error value for the first item with other error values of the first plurality of error values for other items of the plurality of items belonging to the first dimension to generate a first aggregate error for the first dimension; aggregate the second error value for the first item with other error values of the second plurality of error values for the other items of the plurality of items belonging the first dimension to generate a second aggregate error for the first dimension; based on the second aggregate error being less than the first aggregate error, determining that the second plurality of models is superior to the first plurality of models for the first dimension; displaying, by a user interface, a user interface element showing the first dimension, the first aggregate error, the second aggregate error, and a label indicating that the second plurality of models is superior to the first plurality of models for the first dimension.

### BRIEF DESCRIPTION OF THE DRAWINGS

FIG. 1 is network diagram of an environment in which aspects of the present disclosure may be implemented.

FIG. 2 is flowchart of a method according to aspects of the present disclosure.

FIG. 3 illustrates a table user interface element.

FIG. 4 illustrates a chart user interface element.

FIG. 5 illustrates a chart user interface element.

FIG. 6 illustrates a chart user interface element.

FIG. 7 is a block diagram of a computing system.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

In example aspects, understanding, tracking, and comparing the accuracy and coverage of models is important for improving computer model systems. Examples of such computer models include forecasting models that can, during inference, predict future time-series data. Measuring such forecasts generated by these models can highlight the specific strengths and weaknesses of a given model, revealing bugs, providing model visibility, and suggesting a path for future development by showing what works well and what does not. Such forecast measurement can make spotting model deficiencies easier. For example, when comparing two forecasts of different models, differences can become obvious, versus looking only at the properties of a single model.

In example aspects, model measurement tools disclosed herein enable cross-model comparisons. Such tool provide various advantages in the technical field of model development, maintenance, and deployment. For example, aspects of the present disclosure enable modification of a model followed by testing to determine whether the modified model improves forecasts in an expected manner, compared to the previous version of the model. These improvements can be demonstrated by comparing to a baseline modeling system, such as a simple forecast forward of previous actual data. Further improvements can be demonstrated by comparing two competing model systems and learning under what circumstances one performs better than the other.

In example aspects, a measurement and comparison system designed for evaluating systems of models is disclosed. The system provides a standardized library for assessing forecast accuracy through two fundamental metric types: point metrics that evaluate individual predictions and roll-up metrics that measure aggregated groups of predictions across configurable dimensions. The system addresses a challenge in model evaluation by enabling comprehensive system-level assessment rather than individual model comparisons. This may be particularly important when dealing with a modeling infrastructure that uses many different and individually trained models. For example, such a system-level modeling assessment system is particularly advantageous in modeling systems that involve millions of time series models generating billions of predictions. Furthermore, the system provides checks and confidence intervals to determine whether changes represent significant improvements or degradations in forecast accuracy.

In example aspects, the system provides flexible aggregation capabilities. Users can analyze forecast performance across multiple relevant dimensions such as departments, time horizons, seasonality factors, and item lifecycle stages. The system allows for custom user-defined dimensions levels through configurable categorical variables. This flexibility is crucial for understanding performance across different models in a multi-model system.

In example aspects, the system includes visualization components that generate condensed displays showing key metrics and statistical significance. These displays can be automatically generated and distributed. For example, the system includes automated visualization capabilities and coverage analysis to detect forecast availability issues, providing a comprehensive view of system performance. It includes visualization approaches for comparing system improvements, including a unique and advantageous visualization for viewing system-level changes that excludes nearly identical performances to focus on meaningful differences.

In example aspects, the system's architecture is designed to handle the complexity of evaluating entire forecasting systems rather than individual models. This system-level evaluation capability is particularly important in production environments where multiple interconnected models must work together. The technology includes data connection utilities for accessing forecast and actual sales data and can integrate with ML operations platforms. In example aspects, the system advantageously combines standardized metrics, automated analysis, flexible aggregation, and integrated reporting in a way that specifically addresses the challenges of large-scale system that use multiple models. The system's ability to handle complex trade-offs between different models, while providing automated statistical analysis and standardized evaluation methodologies, represents improvements in the field of model evaluation and development.

In some instances, demand over time, which can be forecasted by models disclosed herein, is a complex stochastic process dependent on many variables, some of which may be unknown or unknowable. Given this complex stochastic nature of forecasting demand, computer models may be useful. Because computer systems can process, store, and exchange data in ways that go far beyond what humans can perform, computer models may forecast demand using methods that are distinct from any related human methods for forecasting data. The effectiveness of such a forecasting system may depend on various factor, such as the ability to measure and iteratively improve model performance, quantity and quality of training data, the features used by the forecasting system, hyperparameters of the forecasting system, responsiveness to user inputs, or other factors.

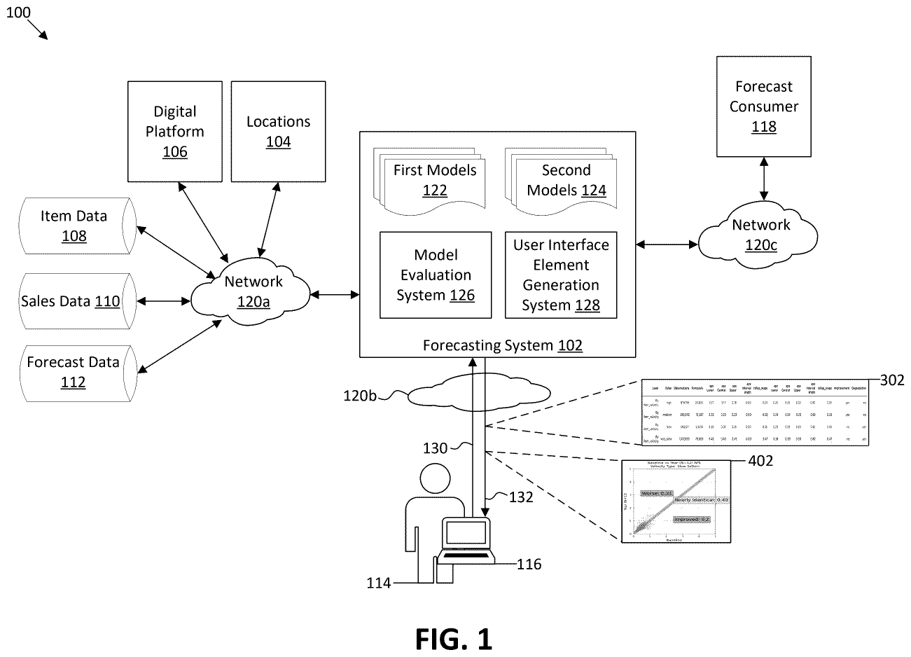

In example aspects, a forecasting system disclosed herein may forecast demand for a plurality of items. For an example item, the forecasting system may forecast the demand for the example item at each of a plurality of locations (e.g., a plurality of individual stores or regions), may forecast the demand for the example item generally (e.g., across all locations), or may forecast demand for the example item across different fulfillment channels (e.g., a digital fulfillment process, a customer pickup fulfillment process, or an in-store fulfillment process). To do so, the forecasting system may apply one or more models that are trained on historical demand data associated with the example item, which may include historical sales for the example item. Accounting for this historical demand data and other considerations, the models may output a demand forecast. Example aspects of the forecasting system are illustrated in connection with FIG. 1.

FIG. 1 illustrates an example network environment 100 in which aspects of the present disclosure may be implemented. In the example shown, the environment 100 includes a forecasting system 102, locations 104, a digital platform 106, item data 108, sales data 110, forecast data 112, a user 114, a computing device 116, a forecast consumer 118, and networks 120a-c. In some embodiments, one or more of the components illustrated in FIG. 1 may be associated with a common entity. For example, one or more of the components illustrated in FIG. 1 may be part of an information system of an organization or may be communicatively coupled with aspects of an information system of an entity. In some embodiments, the entity is a retailer. In some embodiments, the entity may be a manufacturer, logistics organization, software organization, or other type of entity.

The forecasting system 102 may be a collection of hardware and software configured to, among other things, forecast demand. In some embodiments, the forecasting system 102 may use computer models to generate demand forecasts for items. In examples, the items are offered for sale by a retailer. In some embodiments, aspects of the forecasting system 102 may be distributed across different computing environments. In some embodiments, the forecasting system 102 may receive data from one or more of the components 104-118, generate demand forecast using models, and may output demand forecast to the forecast consumer 118.

The forecasting system 102 may be used to generate different types of demand forecasts at the item level, class level, or entire retail chain level, and for overall demand, digital demand (e.g., purchases via website or mobile application), or in the store demand. An example of such a modeling approach is described in U.S. Pat. No. 11,373,199, entitled “Method and System for Generating Ensemble Demand Forecasts”, the disclosure of which is hereby incorporated by reference in its entirety. In further examples, the demand forecasting model may be a chain-level model that forecasts overall demand for an item based on item attributes. Such a modeling approach is described in U.S. Pat. No. 11,182,808, entitled “Method and System for Attributes Based Forecasting”, the disclosure of which is hereby incorporated by reference in its entirety.

The forecasting system 102 includes components for performing one or more ore model evaluation and model comparison. In the example shown, the forecasting system 102 includes first models 122, second models 124, a model evaluation system 126, and a user interface element generation system 128.

The forecasting system 102 includes a plurality of forecasting models for forecasting demand. For example, the forecasting system 102 can generate a plurality of forecasts for a plurality of items using a plurality of forecasting models. The plurality of models can include item-specific models, such as models that forecast demand for a particular item at varying degrees of granularity with respect to location (e.g., a particular location, a region, or a full supply chain) and with varying fulfillment characteristic, such as ship-from-store demand, digital demand, or walk-in demand. Additionally, the plurality of models can include models that forecast demand for a group of items, such as for a department or class of items or for a set of items that shares a common attribute (e.g., items sensitive to a particular season, item with similar sales patterns, etc.), and these forecasts can likewise be generated at different granularities with respect to location and with different fulfillment characteristics. Examples of the plurality of models that can be executed to generate a plurality of forecasts include the first models 122 or the second models 124.

The first models 122 and the second models 124 may be different systems of models. For example, the first models 122 can include a plurality of models, one or more of which are different from a second plurality of models of the second models 124. In some embodiments, one or more of the models of the first models 122 or second models 124 may be a general additive mixed model (GAMM). In some embodiments, one or more of the models of the first models 122 or second models 124 may be a general additive model (GAM) or a different model. In some embodiments, one or more of the models of the first models 122 or second models 124 may be a machine learning model. In some instances, a first item may be associated with a first model type of the first models 122 or second models 124 and a second item may be associated with a second model type of the first models 122 or second models 124. In some embodiments, the models of the first models 122 or second models 124 may forecast demand for an item based on a plurality of item features. In examples, the item features may include one or more features from the item data 108. In some embodiments, the models of the first models 122 or second models 124 include location-based and time-based features for forecasting demand for a given item.

In some embodiments, the models of the first models 122 or second models 124 may include a plurality of location-specific models and may include a model for a group of locations (e.g., for a full supply chain). Thus, when forecasting demand for an item, a location-specific model may be executed to forecast item demand at a particular location, and a chain-level model may be applied to determine an overall item demand forecast. In some embodiments, the chain-level model includes an aggregation of location-specific models.

In some embodiments, the models of the first models 122 or second models 124 include item-specific forecasting models. In such an embodiment, an item-specific forecasting model of the models of the first models 122 or second models 124 may be trained using historical demand data for the item. In some embodiments, the models of the first models 122 or second models 124 may be associated with a list of items for which the models of the first models 122 or second models 124 are trained to generate a demand forecast. In some embodiments, the models of the first models 122 or second models 124 may be configured to generate a demand forecast at a particular time or a range of times.

The structures of features may vary within a given model of the models of the first models 122 or second models 124. For example, a forecasting model may include a combination of random effects, fixed effects, linear features, non-linear features, smooth terms, random effects, intercepts, or other types of features. In some embodiments, a fixed effect is a linear term and a smooth term is a non-linear term. In some embodiments, a smooth term models forecasting variability for groups of items. Different features may be modeled using different feature types. For example, a seasonality feature may be modelled as a smooth term, whereas a store feature may be modelled as a random effect, or vice-versa. Additionally, depending on a model type, the features may vary. For example, an item-specific forecasting model that determines item forecasts for a digital or store demand may include different features than a store or chain-level model that determines demand at the store or chain-level.

In some embodiments, a forecasting model of the models of the first models 122 or second models 124 includes an ensemble of forecasting models. For example, for a given item or group of items, the forecasting model may include different models depending on an item, location, or time granularity at which demand forecasts are being generated. Additionally, in some embodiments, the forecasting model may include a first item-specific model and also a plurality of forecasting models for similar items, thereby enabling the forecasting model to perform multiple passes if needed to forecast demand for the item, such as a first pass with the first item-specific forecasting model and a subsequent pass that aggregates and weighs demand forecasts from the plurality of forecasting models for the similar items.

In some embodiments, different features, and different techniques for modelling features, may be altered or retained to improve model accuracy by capturing differences in the training data that are pertinent to each model, while still enabling efficient backend resource utilization, such as code re-use and shared storage, for model features that are common across models. Experimental development of model alterations and improvements can be enabled by the model evaluation system 126 and user interface element generation system 128 to determine which modifications and helpful for which forecasts and which modifications are not helpful or even degrade performance. By developing and managing models in this way, model accuracy may be improved without an associated increased demand for computer resources, and in fact, memory storage space and training compute times may be decreased in some instances by re-using components across models while making changes that are determined to be advantageous by showing reduced forecasting errors.

In some embodiments, the first models 122 are baseline models. The baseline models can include models that generate forecasts based on or more of a previous week's sales (e.g., extrapolating a previous week's sales forward), a previous year's sales (e.g., using sales history from a same week last year), or a historical average (e.g., using a 52-week rolling window of sales history from a previous two years). In some embodiments, the second models 124 include a plurality of GAMM models while the first models 122 are baseline models, thereby enabling comparisons of different types of modeling systems. Although only the first models 122 and the second models 124 are shown, the forecasting system 102 can include additional sets of models, such as other models used for validating forecasting performance or for generating demand forecasts to be used in downstream applications.

In some embodiments, the second models 124 are compared against the first models 122, or vice-versa. In some embodiments, models of the second models 124 may correspond with models of the first models 122. For example, an example model of the second models 124 may generate forecasts for an example item, or group of items, at an example location, or group of locations, whereas an example model of the first models 122 may generates forecasts for the same example item, or group of items, at the same example location, or group of locations. In such embodiments, there may be differences between the second models 124 and the first models 122. The differences may correspond to model characteristics that are being tested by a model developer. Examples of differences between the second models 124 and the first models 122 can include one or more of the following: a model of the second models 124 may have a different architecture than a corresponding model of the first models 122; a model of the second models 124 may be trained using different training data, or using different training algorithms, than a corresponding model of the first models 122; hyperparameters of a model of the second models 124 may be different from hyperparameters of the first models 122; the second models 124 may include more, or fewer, models than the first models, even if forecasts for the same items are ultimately generated; different parameters used during training or inference of a model of the second models 124 can be used relative to parameters used during training or inference of a corresponding model of the first models 122; or there may be other ways in which second models 124 and first models 122 differ.

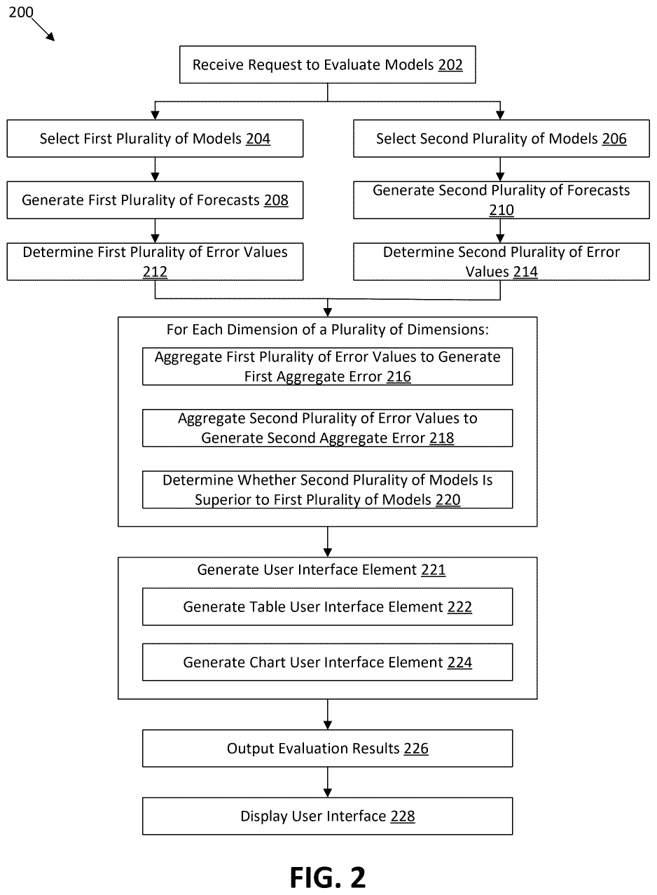

The model evaluation system 126 can include software and hardware for evaluating models. For example, the model evaluation system 126 can evaluate performance of the first models 122 and the second models 124. Furthermore, the model evaluation system 126 can compare models. As an example, the model evaluation system 126 can determine whether a first model or a second model generated more accurate forecasts for a particular item or group of items. Moreover, the model evaluation system 126 can compare pluralities, or systems of models. For example, the model evaluation system 126 can determine whether a first plurality of models or a second plurality of models generated more accurate forecasts for different groups of items. In some embodiments, the model evaluation system 126 can perform one or more operations described in connection with FIG. 2.

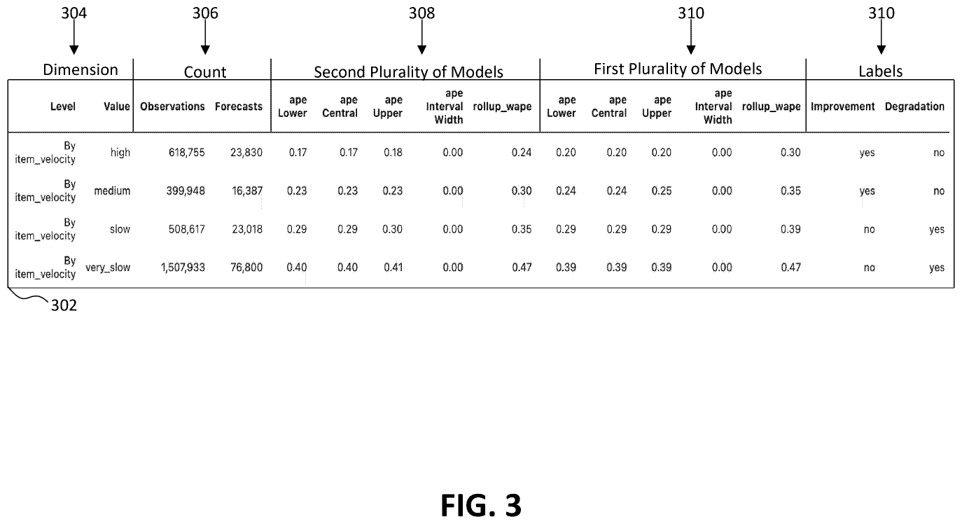

The user interface element generation system 128 can include software and hardware for creating user interface elements, such as, for example, visualizations or reports to be displayed by a user interface. The user interface element generation system 128 can generate user interface elements showing results generated by the model evaluation system 126. For example, the user interface element generation system 128 can generate data for a table and chart to be displayed. Furthermore, the user interface element generation system 128 can create a report that includes a plurality of user interface elements, such as one or more of the table or chart. Example operations of the user interface element generation system 128 are described in connection with FIG. 2, and example user interface elements are illustrated and described in connection with FIGS. 3-6.

The locations 104 may be one or more physical locations associated with a retailer. In some embodiments, the forecasting system 102 may generate demand forecast for a location or group of locations of the retail locations 104. In some instances, a customer may purchase or pickup an item from a retail location of the retail locations 104, which may be registered as demand for that item from that retail location at the time that the customer purchased or picked up the item. In some instances, an item may be shipped from a retail location of the retail locations 104, which may be registered as demand for that item at the time of purchase or shipment, and may or may not be registered as demand at that location. The retail locations 104 may include stores, warehouses, sortation centers, manufacturing facilities, shipping hubs, offices, or other locations that may be used by an entity associated with components of FIG. 1. When a retail location is a store, the retail location may include distinct physical areas and equipment to facilitate fulfillment of orders according to different fulfillment channels, such as a first area and equipment for shipping items from the store and a second area and equipment for providing items to customers who shop in the store. The store may include equipment, such as cameras, video processing software and hardware, automated scanning devices, robotic processing equipment, and other hardware for registering demand (e.g., item movement, purchases, or shipment) at the store and automatically providing data for that demand to backend systems, such as, for example, the item data 108, sales data 110, or forecasting system 102. In some embodiments, the retail locations 104 may be divided into groups, such as groups based on geography or location type. In some embodiments, the retail locations 104 may include computing systems via which the retail locations 104 may transfer data to and from other components of FIG. 1.

The digital platform 106 may include computer systems that can receive or track demand for items. For example, the digital platform 106 may include one or components that facilitate the purchasing of items. In some embodiments, the digital platform 106 includes a website, such as website of a retailer or a website communicatively coupled with a digital retailer system. In some embodiments, the digital platform 106 may include a mobile application.

The item data 108 may include data related to items associated with a retailer. For example, the items may be sold by the retailer. In some embodiments, the item data 108 may include data for items for which forecasts are generated by models of the forecasting system 102. In some embodiments, for a given item, the item data may include one or more of the following: an item name; an item description; an item price; an item inventory; an item vendor; one or more item images; one or more item attributes; seasonal characteristics of the item; one or more locations associated with the item; one or more classifications of the item; an indication of whether the item is a new item; or other data associated with the item. In some embodiments, the forecasting system 102 may use data of the item data 108 to forecast item demand and to determine item similarities.

The sales data 110 may include historical sales data for items, such as items of the item data 108. In some embodiments, the historical sales data for an item may correspond with historical demand for the item. In some embodiments, the sales data 110 includes separate data that represents actual sales and data that represents demand, which may include synthetically generated sales to account for stockouts, new items, or other instances in which sales data may not accurately reflect demand. In other embodiments, such data may be combined. In some embodiments, the sales data 110 may include sales data for an item at a particular location or group of locations. In some embodiments, the sales data 110 is time series data. For example, the sales data 110 may include historical sales data for an item at a location over time, and the sales data 110 may also include historical sales data over time for the item across a supply chain. Different granularities of time are possible. For example, the sales data 110 may include sales per day, per week, per month, per quarter, per year, per a combination thereof, or per another time metric. In some embodiments, the sales data 110 may include sales data generated at the digital platform 106, which may include sales at a website. In some embodiments, the sales data 110 may include synthetic data that is derived at least in part from historical sales data. In some embodiments, the sales data 110 is continuously updated as sales are registered at one or more of the retail locations 104 or the digital platform 106. For example, the sales data 110 may be updated in real time. In some embodiments, sales data 110 is provided to the forecasting system 102, and the forecasting system 102 may use the sales data 110 to train a forecasting model. In some embodiments, the sales data 110 is converted into a standardized format. For instance, sales generated at one of the retail locations 104 may have a different format than sales generated at the digital platform 106, and these formats may be standardized in the sales data 110.

The forecast data 112 may include current and past forecasts for items, such as items of the item data 108. In some embodiments, the forecast data 112 is time series data. For example, the forecast data 112 may include demand forecasts for one or more items over time, such as per day, per week, per month, per quarter, per year, per a combination thereof, or per another time metric. The forecast data 112 may be generated by the forecasting system 102. The forecast data 112 may be provided by the forecasting system 102 to the forecast consumer 118. In some embodiments, the forecast data 112 may be compared with the sales data 110 to determine an accuracy of the forecasting system 102. For example, the first models 122 and second models 124 may generate demand forecasts of the forecast data 112, and such demand forecasts can be compared against a validation set of the sales data 110 to determine performance of the first models and the second models 124. In some embodiments, the forecasting system 102 may check the forecast data 112 for anomalies.

The user 114 is a person or machine that develops or maintains models of the forecasting system 102. As an example, the user 114 may create or modify one or more models and provide those models to the forecasting system 102. For example, the user 114 can provide the second models 124 to the forecasting system 102 for evaluation and comparison against the first models 122.

The computing device 116 can be a device used by the user 114. For example, the computing device 116 can send data to and receive data from the forecasting system 102. The computing system 116 can be a phone, laptop, or other type of computing device. The computing device 116 can include a screen that displays a user interface comprising user interface elements generated by the user interface element generation system 128.

The forecast consumer 118 may be a system or person that receives data from the forecasting system 102. For example, the forecast consumer 118 may receive demand forecasts or model evaluations from the forecasting system 102. In some embodiments, the forecast consumer 118 may, in response to receiving a forecast from the forecasting system 102, automatically adjust an inventory level for one or more items based on data of the forecast.

In some embodiments, the forecast consumer 118 may be an application that includes a graphical user interface (GUI). The application may be, for example, a web application. The GUI may include visualizations of data received from the forecasting system 102, and the GUI may include selectable input fields for providing data to the forecasting system 102. In some embodiments, a user may query the forecasting system 102 to generate a demand forecast or to compare demand forecast models by using components of the GUI. In some embodiments, the forecast consumer 118 may access the item data 108, the sales data 110, or the forecast data 112.

In examples, the forecast consumer 118 may represent a user affiliated with an enterprise associated with the forecasting system 102. For example, the forecast consumer 118 may be an employee, such as a business analyst, data scientists, or the like who is seeking to generate forecasts regarding various types of business operations, such as forecasted demand for goods or services of the enterprise, forecasted supply issues within an enterprise supply chain, and the like. In some embodiments, the forecast consumer 118 is the user 114, or vice-versa.

Although the example of FIG. 1 depicts a single forecast consumer 118, the forecasting system 102 may be coupled with a plurality of forecast consumers, each of which may be a different type of system or may be a common type of system.

Furthermore, the forecasting system 102 may simultaneously communicate with a plurality of forecast consumers.

One or more of the components in the example of FIG. 1 may exchange data over one or more of the networks 120a-c. Each of the networks 120a-c may be, for example, a wireless network, a wired network, a virtual network, the internet, or another type of network. Furthermore, each of the networks 120a—may be divided into subnetworks, and the subnetworks may be different types of networks.

As shown by the example operation 130, the user 114 can submit a request to the forecasting system 102 to evaluate a plurality of forecasting models. For example, the user 114 can provide new or modified models to the model evaluation system 126 along with a request to evaluate the plurality of models against a different set of models. For example, the user 114 may request a comparison of the second models 124 against the first models 122.

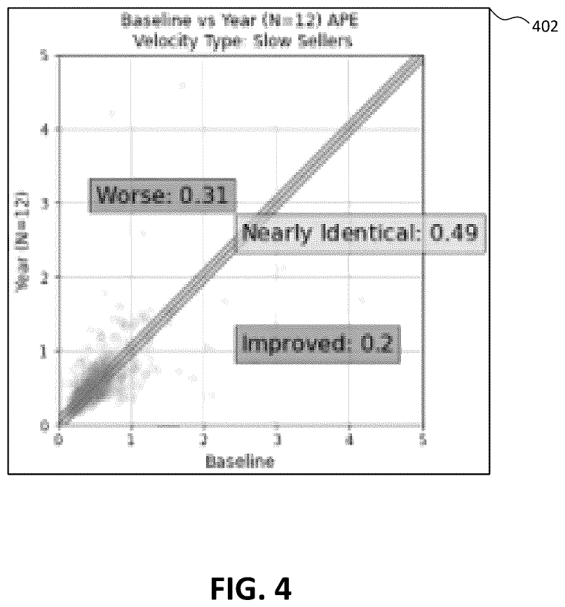

As shown by the example operation 132, the user 114 can receive data from the forecast system 102. The data can include results from the model evaluation requested by the user. In the example shown, the data includes a table user interface element 302 and a chart user interface element 502. The user interface elements 302 and 402 show data comparing performance of the second models 124 against the first models 122. Example aspects of the user interface elements 302 and 402 are further described below in connection with FIGS. 3 and 4, respectively. In some embodiments, the computing device 116 displays a user interface showing data received from the forecasting system 102.

FIG. 2 is a flowchart of an example method 200. Aspects of the method 200 can be used to evaluate a plurality of models. In some embodiments, the forecasting system 102 can perform steps of the method 200. For example, the model evaluation system 126 may perform one or more steps of the method 200. Furthermore, the user interface element generation system 128 may perform one or more steps of the method 200.

In the example shown, the model evaluation system 126 can receive a request to evaluate models (step 202). In some embodiments, the request may be received from the user 114. In some embodiments, the request is triggered in response to a scheduled event corresponding to model evaluation. The request can include various data that can be used by the model evaluation system 126 to evaluate models. As examples, the request can include one or more of the following: an identification of the first models; an identification of the second models; items, such as item identifiers or item attributes, for which evaluated forecasts are to be generated; time periods for which evaluated forecast are to be generated; one or more dimensions for which forecasts will be evaluated; validation data; run-time constraints or parameters for forecast generation or comparison; metrics to be used during evaluation; an epsilon value used to determine whether two forecasts are sufficiently similar; user interface elements, and characteristics thereof, to be generated as part of model evaluation and comparison; or other data related to a model evaluation request.

In the example shown, the model evaluation system 126 can evaluate the first plurality of models 122, as shown by the steps 204, 208, and 212, and the model evaluation system 126 can evaluate the second plurality of models 124, as shown by the steps 206, 210, and 214. In some embodiments, the model evaluation system 126 can simultaneously evaluate the first plurality of models 122 and the second plurality of models 124. In some embodiments, evaluation data, such as error values, may already exist for the first plurality of models 122 or the second plurality of models 124. For example, the first plurality of models 122 may be baseline models or models against which many other models are compared. Accordingly, evaluation results for the first plurality of models 122 may have previously been determined and stored for fast and repeated comparisons against models that are being tested, such as the second plurality of models 124.

In the example shown, the model evaluation system 126 can select the second plurality of models (step 206). For example, the user 114 may have uploaded the second plurality of models 124 and included them as part of a request to perform model validation. In example aspects the model evaluation system 126 can select the first plurality of models (step 204). The first plurality of models may have been selected by the user 114 as part of a comparison request for the second plurality of models.

In the example shown, the model evaluation system 126 can generate a first plurality of forecasts using the first plurality of models (step 208) and generate a second plurality of forecasts using the second plurality of models (step 210). The forecasts may be time-series predicted demand generated for a plurality of individual items, or groups of items. The plurality of items may include a subset of items of an item catalog described in connection with the item data 108 of FIG. 1. In some embodiments, the first plurality of forecasts and the second plurality of forecasts include forecasts for the same items and times. For example, a first model of the first plurality of models 122 can generate a forecast for a first item, and a second model of the second plurality of models 124 can generate a different forecast for the same item. Example aspects of demand forecasts, including differing granularities associated therewith are described above in connection with FIG. 1.

In the example shown, the model evaluation system 126 can determine a first plurality of error values using the first plurality of forecasts (step 212) and determine a second plurality of error values using the second plurality of forecasts (step 214). For example, regarding the second plurality of error values, the model evaluation system 126 can compare the second plurality of forecasts to validation data. Regarding the first plurality of error values, the model evaluation system 126 can compare the first plurality of forecasts to the validation data. The validation data can include historical, future, or synthetic sales data that the models attempted to forecast. In some embodiments, the validation data includes sales data that was withheld when training the second plurality of models.

The error values may correspond to model performance, such that a higher error corresponds with inferior model performance and lower error corresponds with superior model performance. In some embodiments, the error values are for particular items. For example, an example error value can correspond to a difference between a forecasted value for an example error and an actual value, or validation value, for the item, as determined from the validation data. Depending on the embodiment, error values can be represented by the different metrics. As examples, the error values may include one or more of the following: a difference between a forecasted value and an actual value; an absolute error; a bias; an absolute percentage error (APE); a weighted APE; a symmetric APE; a log percentage error; a log error; or another error.

In the example shown, the model evaluation system 126 can compare performance of the first plurality of models and the second plurality of models across one or more dimensions. To do so, the model evaluation system 126 can repeat the steps 216-220 for each dimension of the one or more dimensions.

A dimension defines a group of forecasts. In some embodiments, dimensions define groups of forecasts by identifying items for which forecasts are generated. For example, an example dimension may be “seasonal” items, such that all items that are tagged as “seasonal” belong to the example dimension. As another example, an example dimension may be items belonging to a certain category of items, such as “pantry” items, or “new” items. In some embodiments, dimensions include different attributes of items. For example, a first dimension may include slow-selling items, a second dimension may include fast-selling items, and a third dimension may include very fast-selling items. As other examples, a dimension can include forecasts for one-week, two-weeks, or another amount of time in the future. As another example, a dimension can be forecasts for which a forecast value is greater than an actual value. Other examples of dimensions include the following: item release date; age of item; whether an item has a promotion, and if so, the type of promotion; a degree to which an item is influenced by season; whether a forecast is for a holiday week or a non-holiday week; the degree to which an item is elastic; a source country of the item; a degree to which an item is susceptible to stockouts; or other manners of grouping forecasts or items. In some embodiments, a dimension is a combination of two or more other dimensions. In some embodiments, the dimensions are defined by the user 114 and submitted with a request to conduct model evaluation.

The steps 216-220 are described for an example dimension.

In the example shown, the model evaluation system 126 aggregates error values from the first plurality of error values to generate a first aggregate error (step 216). For example, the model evaluation system 126 can identify the error values, and the corresponding items to which the error values correspond, that match the example dimension. For instance, if the example dimension is “holiday items” then the model evaluation system 126 can identify error values in the first plurality of error values for forecasts in the first plurality of forecasts generated for the holiday items. Having done so, the model evaluation system 126 can aggregate the error values. Depending on the embodiment, different metrics can be used to aggregate the error values. Examples of aggregate error values include the following:

$$\begin{matrix}Roll - up Bias := \frac{{\sum }_{ij} {f}_{ij} - {a}_{ij}}{{\sum }_{ij} {a}_{ij}} \\ Roll - up WAPE := \frac{{\sum }_{ij} \vert {f}_{ij} - {a}_{ij} \vert}{{\sum }_{ij} {a}_{ij}} \\ Roll - up WMAPE := \frac{{\sum }_{ij} {w}_{ij} \cdot \frac{\vert {f}_{ij} - {a}_{ij} \vert}{{a}_{ij}}}{{\sum }_{ij} {w}_{ij}} \\ Roll - up wW MAPE := \frac{{\sum }_{ij} {w}_{ij} \cdot \vert {f}_{ij} - {a}_{ij} \vert}{{\sum }_{ij} {w}_{ij} \cdot {a}_{ij}} \\ Roll - up MALE := mean ( \vert log ( {f}_{ij} + 1 ) - log ( {a}_{ij} + 1 ) \vert ) \\ Roll - up RMSLE := \sqrt{mean ( {log ( {f}_{ij} + 1 )}^{2} - {log ( {a}_{ij} + 1 )}^{2} )}\end{matrix}$$

Where i represents a forecast id, j represents a forecast horizon, N represents the number of forecasts analyzed, and w represents a weight factor.

In the example shown, the model evaluation system 126 aggregates error values from the second plurality of error values to generate a second aggregate error (step 218), example aspects of which are described in connection with the step 216.

In the example shown, the model evaluation system 126 determines whether the second plurality of models is superior to the first plurality of models with respect to the example dimension (step 220). To do so, the model evaluation system 126 may, for example, compare first aggregate error generated at the step 216 with the second aggregate error generated at the step 218. In some embodiments, if the second aggregate error is less than the first aggregate error, then the model evaluation system 126 determines that the second plurality of models is superior to the first plurality of models for the dimension, and if the second error is greater than the first aggregate error, then the model evaluation system 126 determines that the second plurality of models are inferior to the first plurality of models for the dimension. In some embodiment, the second aggregate error must be greater than or less than the first aggregate error value by a threshold value for the model evaluation system 126 to determine that the second plurality of models is inferior to or superior to the first plurality of models. If the first aggregate error value and the second aggregate error value do not differ by more than the threshold, then it may be determined that second plurality of models are neither superior to nor inferior to the first plurality of models. In some embodiments, the determination of whether the second plurality of models is superior to the first plurality of models is based on the percentages (e.g., a threshold percentage of improvement) that are illustrated and described in the examples of FIGS. 4-6. For example, in some embodiments, the model evaluation system 126 determines whether the second plurality of models is superior to or inferior to the first plurality of models based on a percentage of models of the second plurality of models that outperformed corresponding models of the first plurality of models, example aspects of which are illustrated and described in connection with FIG. 4-6.

In some embodiments, the model evaluation system 126 can compare error values of the first plurality of error values with error values of the second plurality of error values. Based on the comparison, the model evaluation system 126 can exclude similar error values associated with the corresponding models of the first plurality of models and the second plurality of models and determine whether the second plurality of values is superior to the first plurality of models without considering the excluded values.

In the example shown, the user interface element generation system 128 can generate user interface elements (step 221). For example, the user interface element generation system 128 can generate user interface elements that comprise results from the model evaluation system 126. For example, the user interface element generation system 128 can generate a table user interface element (step 222), an example of which is illustrated in FIG. 3. As another example, the user interface element generation system 128 can generate a chart user interface element (step 224), examples of which are illustrated in FIGS. 4-6.

In the example shown, the forecasting system 102 can output evaluation results (step 226). For example, one or more of the generated user interface elements may automatically be output to the user 114 or the forecast consumer 118. Additionally, the forecasting system 102 can output other data generated by the model evaluation system 126.

In the example shown, a user interface may be displayed (step 228). For example, the computing device 116 or the forecast consumer 118 can display one or more of the user interface elements generated by the user interface element generation system 128.

FIG. 3 illustrates an example table user interface element 302 showing results from comparing the first plurality of models and the second plurality of models. The table user interface element 302 includes a dimension section 304 comprising rows representing different dimensions, such as item velocity categories including “high”, “medium”, “slow” and “very_slow”. The table includes a count section 306 showing observation counts and forecast counts for each dimension. The table includes sections 308 and 310 showing error metrics for the second plurality of models and first plurality of models respectively. The error metrics include lower, central, and upper absolute percentage error (APE) values, APE interval widths, and rollup weighted absolute percentage error (WAPE) values. The table also includes labels indicating whether the second plurality of models showed improvement or degradation compared to the first plurality of models for each dimension.

The table user interface element 302 enables detailed comparison across different dimensions. This granular breakdown allows analysis of model performance across different dimensions, such as, in the example shown, different types of items with varying sales patterns. The error metrics reveal that both model sets generally show increasing error rates as item velocity decreases, with WAPE values ranging from 0.24 to 0.47 for the second plurality of models.

The improvement and degradation labels in the table provide quick visual indicators of relative model performance. For high and medium velocity items, the second plurality of models shows improvement, as shown by lower error values. Accordingly, for these dimensions, the labels section 310 indicates that the second plurality of models are superior to the first plurality of models. Conversely, for slow and very slow velocity items, the models show that the second plurality of models have error values that are unchanged, or higher, than error values for the first plurality of models. Accordingly, the labels section 310 indicates that the second plurality of models are inferior to the first plurality of models for these categories. The table of FIG. 3 advantageously shows a nuanced, dimension-based comparison of the second plurality of models against the first plurality of models, revealing specific instances where the second plurality of models has, in fact, improved upon the first plurality of models while also showing where such improvement was not achieved.

FIG. 4 illustrates an example chart 402 showing comparison results between baseline models and year-ahead models for slow-selling items. In this example, the x-axis shows error results for the first plurality of models 122 and the y-axis shows error results for the second plurality of models 124. Each point of the plurality of points in the chart 402 shows the respective errors produced by the first plurality of models and the second plurality of models.

The chart displays three categories of results: “Worse” representing 31% of items, or models, where the second plurality of models 124 performed worse than first plurality of models 122, “Nearly Identical” representing 49% of items, or models, where performance was similar, and “Improved” representing 20% of cases where the second plurality of models 124 outperformed the first plurality of models 122.

The chart employs a clear visual breakdown of performance categories, using distinct sections to represent the proportions of each outcome. This visualization approach helps quickly identify that nearly half of all forecasts show similar performance between systems of models. In some embodiments, the chart 402 includes an identity line with a thickness (e.g., a stripe) that is represented by the “Nearly Identical” line. The points that are covered by this line are considered sufficiently similar from an error perspective for the first plurality of models 122 and the second plurality of models 124. Points following below and to the right of this line have a higher error from the first plurality of models, indicating that the second plurality of models was an improvement. The opposite is true for points above and to the left of the identity line.

In some embodiments, the chart includes a slidable element that can be used to select an epsilon value. The thickness of the identity line depends on the selected epsilon value. For example, if a higher epsilon value is selected, the thickness of the identity line increases, meaning that, for a given point (e.g., an item or model), the difference in error between the first plurality of models and the second plurality of models must be relatively greater for the second plurality of models to be deemed “Improved” or “Worse” than the first plurality of models for that point.

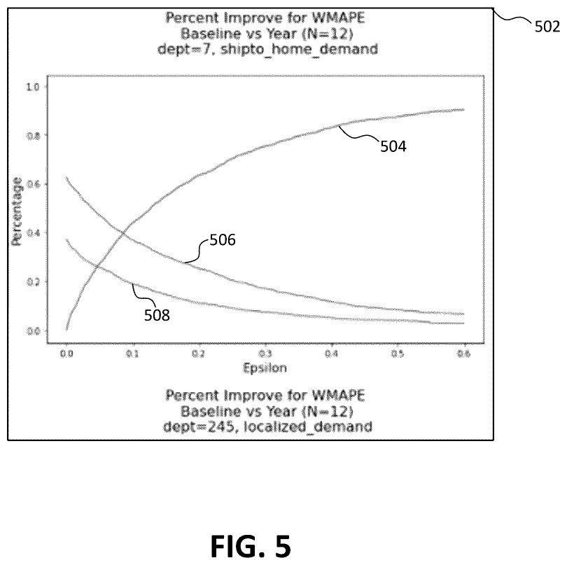

FIG. 5 illustrates example charts showing percent improvement analysis for weighted mean absolute percentage error (WM APE) metrics comparing baseline models (e.g., the first plurality of models 122) versus year-ahead models (e.g., the second plurality of models 124). The top chart shows results for department 7 ship-to-home demand, while the bottom chart shows results for department 245 localized demand. The charts include a y-axis showing percentage values from 0.0 to 1.0, and an x-axis showing epsilon values from 0.0 to 0.6. The charts demonstrate how model improvement percentages vary based on different epsilon thresholds used to determine whether forecasts are significantly different.

The charts incorporate multiple visual elements including trend lines 504, 506, and 508 that track how the percentage of improved forecasts changes as the epsilon threshold increases. The line 504 shows the epsilon value. The line 506 shows the percentage of items or models for which the second plurality of models is an improvement to the first plurality of models. The line 508 shows the percentage of items or models for which the second plurality of models is worse than the first plurality of models. This relationship between improvement percentage and epsilon threshold provides insights into the sensitivity of model comparison results to different definitions of significant improvement.

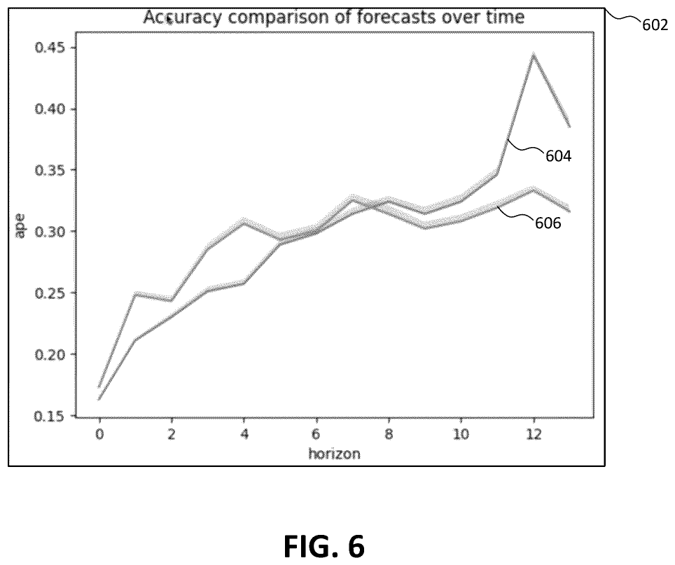

FIG. 6 illustrates an example chart showing accuracy comparison of forecasts over time. The chart includes a y-axis showing accuracy metrics ranging from approximately 0.15 to 0.45, and an x-axis showing forecast horizons from 0 to 12 time periods. Multiple trend lines are plotted showing how forecast accuracy changes across different forecast horizons, enabling comparison of model performance at different time ranges. For example, the line 604 represents performance of the first plurality of models 122 and the line 606 represents performance of the second plurality of models 124.

The chart includes trend lines 604 and 606 that track accuracy metrics over increasing forecast horizons. The generally upward slope of these lines indicates that forecast accuracy tends to decrease (higher error values) as the forecast horizon extends further into the future, which is a common challenge in time series forecasting. However, the lines also show that the second plurality of models are more consistent and significantly superior to the first plurality of models for longer time horizons.

The visualization allows direct comparison of accuracy between different models across the entire forecast horizon from 0 to 12 periods. This temporal comparison capability is particularly valuable for understanding how different modeling approaches handle increasing uncertainty over longer forecast horizons, and for identifying specific time ranges where certain models may perform better than others.

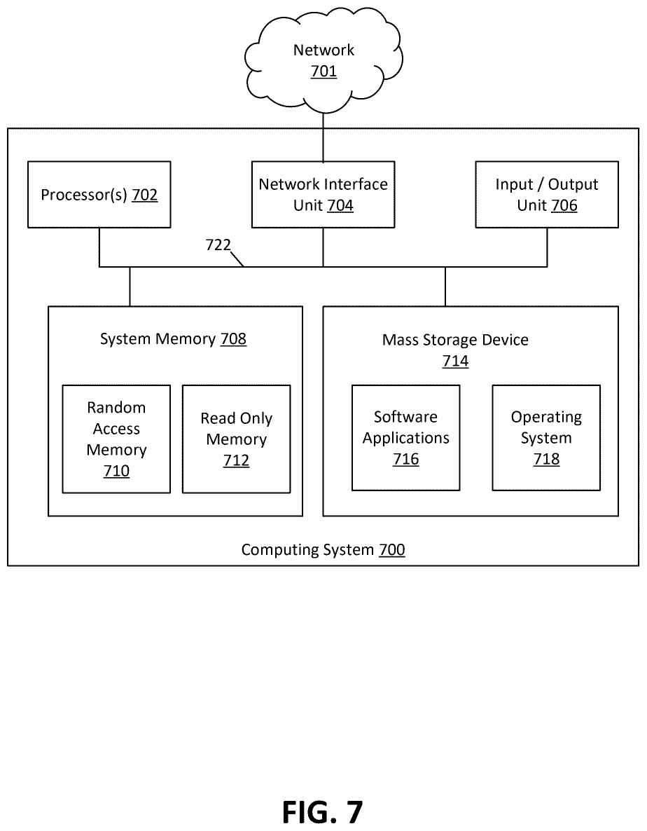

FIG. 7 illustrates an example block diagram of a virtual or physical computing system 700. One or more aspects of the computing system 700 can be used to implement the system and processes described herein.

In the embodiment shown, the computing system 700 includes one or more processors 702, a system memory 708, and a system bus 722 that couples the system memory 708 to the one or more processors 702. The system memory 708 includes RAM (Random Access Memory) 710 and ROM (Read-Only Memory) 712. A basic input/output system that contains the basic routines that help to transfer information between elements within the computing system 700, such as during startup, is stored in the ROM 712. The computing system 700 further includes a mass storage device 714. The mass storage device 714 is able to store software instructions and data. The one or more processors 702 can be one or more central processing units or other processors.

The mass storage device 714 is connected to the one or more processors 702 through a mass storage controller (not shown) connected to the system bus 722. The mass storage device 714 and its associated computer-readable data storage media provide non-volatile, non-transitory storage for the computing system 700. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROM s, DVD (Digital Versatile Discs), other optical storage media, magnetic cassettes, magnetic tape, magnetic disk storage or other magnetic storage devices, or any other medium which can be used to store the desired information and which can be accessed by the computing system 700.

According to various embodiments of the invention, the computing system 700 may operate in a networked environment using logical connections to remote network devices through the network 701. The network 701 is a computer network, such as an enterprise intranet and/or the Internet. The network 701 can include a LAN, a Wide Area Network (WAN), the internet, wireless transmission mediums, wired transmission mediums, other networks, and combinations thereof. The computing system 700 may connect to the network 701 through a network interface unit 704 connected to the system bus 722. It should be appreciated that the network interface unit 704 may also be utilized to connect to other types of networks and remote computing systems. The computing system 700 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the computing system 700 can store software instructions and data. The software instructions include an operating system 718 suitable for controlling the operation of the computing system 700. The mass storage device 714 and/or the RAM 710 also store software instructions, that when executed by the one or more processors 702, cause one or more of the systems, devices, or components described herein to provide functionality described herein. For example, the mass storage device 714 and/or the RAM 710 can store software instructions that, when executed by the one or more processors 702, cause the computing system 700 to receive and execute managing network access control and build system processes.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A system comprising:
a first plurality of models comprising a first model and a second model, wherein the first model generates a first forecast for a first item of a plurality of items and wherein the second model generates a second forecast for a second item of the plurality of items;
a second plurality of models comprising a third model and a fourth model, wherein the third model generates a third forecast for the first item and wherein the fourth model generates a fourth forecast for the second item;
a model evaluation system configured to:
generate, using the first plurality of models, a first plurality of forecasts, the first plurality of forecasts comprising the first forecast for the first item and the second forecast for the second item;
generate, using the second plurality of models, a second plurality of forecasts, the second plurality of forecasts comprising the third forecast for the first item and the fourth forecast for the second item;
compare the first plurality of forecasts to validation data to determine a first plurality of error values comprising a first error value for the first item and a second error value for the second item;
compare the second plurality of forecasts to the validation data to determine a second plurality of error values comprising a third error value for the first item and a fourth error value for the second item;
for a first dimension including with the first item:
aggregate the first error value for the first item with other error values of the first plurality of error values for other items of the plurality of items belonging to the first dimension to generate a first aggregate error for the first dimension;
aggregate the third error value for the first item with other error values of the second plurality of error values for the other items of the plurality of items belonging the first dimension to generate a second aggregate error for the first dimension;
based on the second aggregate error being less than the first aggregate error, determine that the second plurality of models is superior to the first plurality of models for the first dimension;
for a second dimension associated with the second item:
aggregate the second error value for the second item with other error values of the first plurality of error values for other items of the plurality of items belonging to the second dimension to generate a third aggregate error for the second dimension;
aggregate the fourth error value for the second item with other error values of the second plurality of error values for the other items of the plurality of items belonging to the second dimension to generate a fourth aggregate error for the second dimension;
based on the fourth aggregate error being greater than the third aggregate error, determine that the second plurality of models is inferior to the first plurality of models for the second dimension;
a user interface configured to:
display a table user interface element comprising rows representing a plurality of dimensions including the first dimension and the second dimension, a first column including first model error results from the first plurality of models, a second column including second model error results from the second plurality of models, and a third column comprising labels indicating whether, for each dimension of the plurality of dimensions, the second plurality of models improved upon the first plurality of models, wherein the third column includes a first label indicating that the second plurality of models is superior to the first plurality of models for the first dimension and a second label indicating that the second plurality of models is inferior to the first plurality of models for the second dimension; and
display a chart user interface element comprising, for the first dimension, a y-axis showing errors associated with second plurality of models and an x-axis showing errors associated with the first plurality of models, a plurality of points, wherein each point corresponds to an item of the plurality of items, and an identity line that visually separates improved forecasts and degraded forecasts of the second plurality of models relative to the first plurality of models, wherein a point representing the first item is positioned in the graph with a x-value greater than a y-value to show that the third model is superior to the first model for the first item.

2. The system of claim 1, wherein, based on the second aggregate error being less than the first aggregate error, determining that the second plurality of models is improved relative to the first plurality of models for the first dimension comprises:
performing a comparison of the third error value and the other error values of the second plurality of error values with the first error value and the other error values of the first plurality of error values to identify similar models of the first plurality of models and the second plurality of models for forecasting the first item;
based on the comparison, excluding similar error values associated with the similar models; and
determining that the second plurality of models is improved relative to the first plurality of models for the first dimension without using the similar models or the similar error values.

3. The system of claim 2,
wherein the identity line includes a thickness determined based on a selectable threshold similarity value;
wherein the user interface includes a slider for selecting the threshold similarity value, a movement of the slider causing a change to the thickness of the identity line;
wherein the plurality of points include similar points that correspond to the similar error values that are covered by the identity line to show that no significant forecasting differences exist between the similar models for the similar points; and
wherein the chart shows a first percentages of the second plurality of models that are superior to the first plurality of models, and wherein the chart shows a second percentage of the second plurality of models that are inferior to the first plurality of models.

4. The system of claim 1,
wherein the first plurality of models are baseline models that generate forecasts using one or more of a previous week or a previous year baseline;
wherein the second plurality of models forecasting model are generalized additive mixed models (GAMM) comprising smooth terms, random effects, and fixed effects that are trained using previous sales data.

5. The system of claim 1,
wherein the first dimension is a category of items of the plurality of items;
wherein the second dimension is a cross-category item attribute.

6. The system of claim 1,
wherein the first dimension is a first time; and
wherein the second dimension is second time later than the second time.

7. The system of claim 1, wherein the user interface is further configured to display a second chart user interface element showing three lines, wherein a first line represents an epsilon value, wherein a second line represents improvement of the second plurality of models relative to the first plurality of models, and wherein the third line represents degradation of the second plurality of models relative to the first plurality of models, wherein each of the second line and the third line decrease as the first line increases.

8. The system of claim 1, wherein the user interface is further configured to display a second chart user interface element showing, over time, a first change of forecast performance of the first plurality of models and a second change of forecast performance of the second plurality of models, wherein the second chart user interface element shows that the first plurality of models outperforms the second plurality of models at a first time and that the second plurality of models outperforms the first plurality of models at a second time.

9. A method comprising:
generating, using a first plurality of models, a first plurality of forecasts, the first plurality of forecasts comprising a first forecast for a first item of a plurality of items;
generating, using a second plurality of models, a second plurality of forecasts, the second plurality of forecasts comprising a second forecast for the first item;
comparing the first plurality of forecasts to validation data to determine a first plurality of error values comprising a first error value for the first item;
comparing the second plurality of forecasts to the validation data to determine a second plurality of error values comprising a second error value for the first item;
for a first dimension including with the first item:
aggregating the first error value for the first item with other error values of the first plurality of error values for other items of the plurality of items belonging to the first dimension to generate a first aggregate error for the first dimension;
aggregating the second error value for the first item with other error values of the second plurality of error values for the other items of the plurality of items belonging the first dimension to generate a second aggregate error for the first dimension;
based on the second aggregate error being less than the first aggregate error, determining that the second plurality of models is superior to the first plurality of models for the first dimension;
displaying, by a user interface, a user interface element showing the first dimension, the first aggregate error, the second aggregate error, and a label indicating that the second plurality of models is superior to the first plurality of models for the first dimension.
